(19) United States
(12) Patent Application Publication
(10) Pub. No.: US 2004/0126547 A1
(43) Pub. Date: Jul. 1, 2004

(54) Methods for performing substrate imprinting using thermoset resin varnishes and products formed therefrom

(76) Inventor: Boyd L. Coomer, Scottsdale, AZ (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/335,187

(22) Filed: Dec. 31, 2002

(51) Int. Cl. B32B 3/00

(52) U.S. Cl. 428/209; 174/258

(57) ABSTRACT

A method comprising coating a core surface with an A-stage thermoset resin to produce an A-stage thermoset resin layer; partially curing the A-stage resin layer to produce a partially cured thermoset resin layer; and imprinting a plurality of conductor features into the partially cured thermoset resin layer to produce an imprinted substrate is provided. An electronic package comprising a substrate having a plurality of conductor features formed by imprinting, the substrate formed from an A-stage resin that has partially cured; and an electronic component coupled to the substrate is also provided. Coating with an A-stage thermoset resin as part of the imprinting process reduces thickness variation in the layers, provides full, intimate contact with prior layers and eliminates damage to prior layers.

### RELATED APPLICATIONS

The present applications are related to the following applications, which are assigned to the same Assignee as the present application:

Ser. No. ______, entitled “Imprinted Substrates and Methods of Manufacture,” filed on Dec. 18, 2002 (Attorney Docket 884.634US1); and

Ser. No. ______, entitled “Method of Semi-Additive Plating of Imprinted Layers and Resulting Product” filed on ______ (Attorney Docket 884.841US1).

### FIELD

The present subject matter relates generally to methods of imprinting and products formed therefrom, and, more particularly, to substrate imprinting using thermoset resins and products formed therefrom.

### BACKGROUND

Integrated circuits (ICs) are typically assembled into electronic packages by physically and electrically coupling them to a substrate made of organic or ceramic material using a variety of techniques, including surface mount technology (SMT). One or more such IC packages can then be physically and electrically coupled to a secondary substrate such as a printed circuit board (PCB) or motherboard to form an “electronic assembly.”

Each substrate in an electronic assembly may comprise a number of layers. Each layer may include a pattern of metal interconnect lines (referred to herein as “traces”) on one or both surfaces. Each layer may also include vias to couple traces or other conductive structures on opposite surfaces of the layer or on other layers.

An IC substrate typically includes one or more electronic components mounted on one or more surfaces of the substrate. The electronic component or components are functionally connected to other elements of an electronic system through a hierarchy of electrically conductive paths that include the substrate traces and vias. The substrate traces and vias typically carry signals that are transmitted between the electronic components, such as ICs, of the system. Some ICs have a relatively large number of input/output (I/O) terminals (also called “lands” or “pads”), as well as a large number of power and ground terminals.

The formation of conductor features, such as traces and vias, in a substrate typically requires a sequence of complex, time-consuming, and expensive operations that offer ample opportunities for error. For example, forming traces on a single surface of a substrate layer typically requires surface preparation, metallizing, masking, etching, cleaning, and inspecting. Forming vias typically requires drilling, using a laser or mechanical drill. Each process stage requires careful handling and alignment to maintain the geometric integrity of the myriad of traces, vias, and other features. To allow for alignment tolerances, feature sizes and relationships often must be kept relatively large, thus hindering significant reductions in feature density. For example, to provide sufficient tolerance for drilling vias, via pads are typically provided, and these consume significant “real estate.”

Fabrication of a typical multi-layer substrate requires that a large number of process operations be performed. In a known example of a multi-layer substrate, a core layer has a plurality of vias (also referred to herein as “plated through holes” or “PTHs”) and traces. Traces may be formed on one or both surfaces of the core layer. One or more build-up layers, each with traces on one or more surfaces, and typically with PTHs, are formed. The features of the build-up layers can be formed while these layers are separate from the core layer, and the build-up layers may then be subsequently added to the core layer. Alternatively, some features of the build-up layers may be formed after such layers have been added to the core layer.

For the reasons stated above, and for other reasons stated below which will become apparent to those skilled in the art upon reading and understanding the present specification, there is a significant need in the art for methods of electronics packaging that minimize the complexity, time, and cost of fabricating substrates.

### BRIEF DESCRIPTION OF THE DRAWINGS

FIG. 1 illustrates a cross-sectional representation of an electronic assembly incorporating a substrate that is formed by imprinting, in accordance with an embodiment of the invention;

FIG. 2 illustrates a cross-sectional representation of a first step in a method for producing an imprinted substrate comprising providing a core layer, in accordance with an embodiment of the invention;

FIG. 3 illustrates a cross-sectional representation of a subsequent step comprising coating the core layer of FIG. 2 with an A-stage thermoset resin in accordance with an embodiment of the invention;

FIG. 4 illustrates a cross-sectional representation of a subsequent step comprising partially curing A-stage resin of FIG. 3 to produce a partially cured resin.

FIG. 5 illustrates a cross-sectional representation of a subsequent step comprising imprinting the partially cured thermoset resin of FIG. 4, in accordance with an embodiment of the invention;

FIG. 6 illustrates a cross-sectional representation of a subsequent step comprising curing the partially resin of FIG. 5 to the C-stage to produce an imprinted substrate;

FIG. 7 illustrates a cross-sectional representation of a subsequent step comprising performing conventional plating and planarizing processes on the imprinted substrate of FIG. 6, in accordance with an embodiment of the invention;

FIG. 8 illustrates a cross-sectional representation of a subsequent step comprising adding additional layers to the imprinted and plated layers of FIG. 7 to produce a multilayer imprinted package, in accordance with an embodiment of the invention;

FIG. 9 illustrates a cross-sectional representation of a subsequent step comprising applying soldermasks and final surface finish to the multilayer imprinted package of FIG. 8, in accordance with an embodiment of the invention;

FIG. 10 is a block diagram illustrating a method of producing an imprinted substrate, in accordance with an embodiment of the invention;

FIG. 11 is a block diagram illustrating a method of producing an imprinted substrate according to an embodiment of the invention; and

FIG. 12 is a block diagram illustrating a method of producing a multilayer imprinted substrate according to an embodiment of the invention; and

### DETAILED DESCRIPTION OF THE EMBODIMENTS

In the following detailed description of embodiments of the invention, reference is made to the accompanying drawings that form a part hereof, and in which is shown by way of illustration specific preferred embodiments in which the subject matter may be practiced. These embodiments are described in sufficient detail to enable those skilled in the art to practice them, and it is to be understood that other embodiments may be utilized and that mechanical, chemical, structural, electrical, and procedural changes may be made without departing from the spirit and scope of the present subject matter. The following detailed description is, therefore, not to be taken in a limiting sense, and the scope of embodiments of the present invention is defined only by the appended claims.

The Detailed Description that follows begins with a definition section followed by a brief overview of imprinting, a description of the embodiments and a brief conclusion.

Definitions

The term “thermoplastic polymer” or “thermosoftening plastic” or “thermoplastic” as used herein refers to any plastic that can be repeatedly softened upon heating and hardened upon cooling, in contrast to a thermosetting plastic defined below. Thermoplastics do not undergo cross-linking upon heating and can therefore be resoftened. Examples include poly(ethane), polystyrene and polyvinyl chloride (PVC).

The term “thermoset resin” or “thermosetting plastic” or “resin” as used herein refers to any plastic that can be formed into a shape during manufacture, but which sets permanently rigid upon further heating. This is due to extensive cross-linking that occurs upon heating, which cannot be reversed by reheating. Examples include phenol-formaldehyde resins, epoxy resins, polyesters, polyurethane, silicones and combinations thereof. Thermoset resins most often used in the present invention include epoxy resins (“epoxies”), polyimide resins (“polyimides”), bismaleimide resins (e.g., bismaleimide trizaine (BT)) and combinations thereof.

The term “A-stage” as used herein refers to an initial stage (i.e., zero percent cure) in the reaction of some thermosetting resins wherein the resin continues to be soluble (in various solvents such as alcohols and acetone) and fusible. The “A-stage” is characterized by an initial lowering of viscosity as is known in the art. A material in the “A-stage” is typically a liquid that has been dissolved in a solvent. An “A-stage” thermoset resin is often referred to as a “varnish resin” or “resol.”

The term “B-stage” as used herein refers to a secondary stage in the reaction of some thermosetting resins, characterized by a softening of the resin when heated and swelling when in the presence of certain liquids, but without complete fusing or dissolving. The “B-stage” is also characterized by a progressive increase in viscosity. The resin portion of an uncured thermosetting adhesive is usually in this stage. A “B-stage” material is considered a relatively soft, malleable solid, as is known in the art. Materials in the “B-stage” are considered to be more than zero percent cured, but not more than about 10% cured (as measured by Differential Scanning Calorimetry (DSC) described below). Typically, a “B-stage” material is produced from a varnish resin that has been previously applied to a surface and is at a point at which all of the solvent has evaporated due to the application of heat. It is the application of heat that causes some of the free polymers to begin to cure within a short time period, although given sufficient time, any thermoset resin will begin curing. A “B-stage” thermoset resin is also known as a “resitol.”

The term “C-stage” as used herein refers to the third and final stage in the reaction of some thermosetting resins, characterized by the relatively insoluble and infusible state of the resin. Some thermosetting resins in this stage are fully cured, 100% cured, as measured by DSC. A “C-stage” resin is sufficiently rigid to enable additional chemical and mechanical processing to occur on its surface. A “C-stage” resin is also known as “resite.”

The term “Differential Scanning Calorimetry (DSC)”as used herein refers to a thermal analysis method that can show the level of polymerization, such as with a thermoset resin, and hence the percent of cure. If no additional polymerization can occur, the sample being tested is 100% polymerized or cured. More specifically, during DSC heat energy is added to the system. If the added heat is utilized by the tested sample to drive a polymerization reaction, then the sample is not fully cured. If the added heat merely raises the temperature of the system, then the sample is assumed to be fully cured.

The term, “imprint” as used herein, means to form features in a material by forcing a tool against and/or into the material. Imprinting includes stamping, embossing, impressing, extruding, and like processes. Any suitable type of imprint apparatus can be used to make an imprint. The imprint apparatus can contain dies of a variety of shapes and sizes. Generally, shorter dies are used to form trenches while longer dies are used to form vias.

The term “conductor feature” as used herein, means any type of conducting element associated with a substrate, including vias (e.g. blind vias, through vias, etc.) and trenches, such as traces and planes (e.g. surface traces, internal traces, conductive planes, etc.), mounting terminals (e.g. pads, lands, etc.), and the like.

The term “via” as used herein, means any type of conducting element to provide a conductive path between different depths in a substrate. For example, a “via” can connect conductive elements on opposite surfaces of a substrate as well as conductive elements at different internal layers within a substrate. Vias are also referred to as “plated through holes” or “PTHs.”

The term “trench” as used herein, means any type of conducting element to provide a conductive path at a relatively constant depth in a substrate. A “trench” includes traces, ground planes, and terminals as well as lands. For example, a trace may connect conductive elements on one surface of a substrate. A ground plane may provide a conductive path at a relatively constant depth within a substrate. Terminals may provide conductive paths on one surface of a substrate.

The term “electronic assembly” as used herein refers to two or more electronic components coupled together.

The term “electronic system” as used herein refers to any product comprising an “electronic assembly.” Examples of electronic systems include computers (e.g., desktop, laptop, hand-held, server, etc.), wireless communications devices (e.g., cellular phones, cordless phones, pagers, etc.), computer-related peripherals (e.g., printers, scanners, monitors, etc.), entertainment devices (e.g., televisions, radios, stereos, tape and compact disc players, video cassette recorders, MP3 (Motion Picture Experts Group, Audio Layer 3) players, etc.), and the like.

The term “substrate” as used herein refers to the physical object that is the basic workpiece transformed by various process operations into the desired microelectronic configuration. A substrate may also be referred to as a “printed circuit” or “printed wiring board.” A “substrate” may include conducting material (such as copper or aluminum), insulating material (such as ceramic or plastic), and the like, or combinations thereof. Substrates can include layered structures, such as a sheet of material chosen for electrical and/or thermal conductivity (such as copper) covered with a layer of plastic chosen for electrical insulation, stability, and embossing characteristics. A substrate can serve as a dielectric, i.e., an insulating medium that intervenes between two conductors.

Imprinting Overview

Single layer imprinting, imprinting on opposite sides of a core, as well as multilayer imprinting is possible. Single layers are used in applications not requiring significant I/O routing or a substantial power supply, such as flash memory devices, and the like. Two-sided imprinting is useful in flip chip applications, for example. Multilayers are commonly used in a number of applications as is known in the art.

Materials useful for imprinting include thermoplastic polymers and thermoset resins. However, with thermoplastic polymers, the entire package must be reheated to temperatures typically around 300° C. in order to add additional layers, i.e., to laminate. At these temperatures, it is possible to deform or destroy previously imprinted features. Each subsequent layer should be a thermoplastic material that has a lower melting point so that when the new layer is added, the previous layer is not melted and destroyed. The lower melting point thermoplastic can be a different material or can be the same thermoplastic material processed under different conditions to have a lower melting point. Care must also be taken to keep thickness variations between the layers to a minimum.

In contrast, thermoset resins typically do not require temperatures over about 250° C. to cure. Furthermore, once set, thermoset resins do not remelt. Therefore, it is not necessary to use different types of thermoset resins having different melting points when laminating with thermoset resins.

Additionally, high melting point thermoplastics used for imprinting typically require use of a carbon tetraflouride plasma to remove excess polymer at the bottom of imprinted vias. Typically, such plasmas require a high vacuum chamber into which a precursor gas, such as tetrafluoromethane, combined with small amounts of oxygen, is introduced. High frequency radio waves are used to cause the gas to ionize, thus forming the plasma, and attack the surfaces in the chamber. The resulting chemical reaction removes surface atoms from whatever organic material is located in the chamber.

In contrast, thermoset resins do not require the use of plasma for removal of excess material. Rather, the substrates are dipped into tanks of a corrosive chemical, such as an alkaline potassium permanganate solution, concentrated sulfuric acid, and the like, for 10-15 minutes to etch away the surface atoms.

Further, when thermoplastics are used, deposition of a seed layer, i.e., catalyst, (for subsequent metallization) having sufficient adhesion requires use of a sputtering process. Sputtering takes place in a pressure chamber into which the surface needing the seed layer, i.e., the target, is placed. A chrome copper wire is evaporated, causing the deposition of a thin metallic layer onto the target.

In contrast, thermoset resins do not require sputtering to initiate an adequate seed layer. Rather, the substrate is chemically roughened using a suitable chemical, such as an alkaline potassium permanganate solution. The surface is then immersed into a solution, e.g., colloidal palladium chloride, capable of adsorbing onto the exposed surfaces to form a seed layer for subsequent plating processes.

As compared with conventional processes, imprinting has several advantages, including eliminating the laser drilling and photolith processes normally required to create the desired features. (Laser drilling is typically used to ablate the vias, while a photolith process is used to define the areas where plating has occurred and which will be subject to further plating). Furthermore, no “target” is required with imprinting. Therefore, via pads are not needed for the purpose of “locating” a drilled via, although via pads can still be used for other purposes.

Using thermoset resins for the imprinting process provides additional advantages as noted above. Additionally, by applying the thermoset resin as an “A-stage” or “varnish” resin, as described in the embodiments herein, many additional benefits are achieved. For example, use of an A-stage resin to add a layer as opposed to laminating a dry film, i.e., either a thermoplastic or partially cured, e.g., a B-stage, thermoset resin, not only eliminates the uncertainty with respect to whether air bubbles are trapped, material has flowed to the edges of the features, and so forth, it also eliminates any detrimental effects of attempting to overcome these problems. Specifically, use of conventional materials requires application of additional pressure on each layer (up to about 34 atm (500 psi) for thermoplastic materials and about 3.4 atm (50 psi) for thermoset resins applied as B-stage resins), at increased temperatures in order to make sure air bubbles are removed, material has flowed to the edges, as well as to ensure the resulting film sticks sufficiently to the surface being coated. Such pressure can cause damage to features already present on the surface. Use of an A-stage resin eliminates the need for the application of pressure during lamination. Use of an A-stage resin also eliminates any issues regarding film thickness control. Specifically, with conventional lamination using either a thermoplastic or a partially cured thermoset material, the use of increased temperatures as noted above, i.e., in the range of about a 100 to 350° C. increase, also presents difficulties. Although the higher temperatures are required to obtain good adhesion and to cause the film to flow into the uneven surfaces being coated, it also makes it difficult to adequately control film thickness. Furthermore, the use of these elevated temperatures can have a detrimental effect on previously installed components. Use of an A-stage resin does not require elevated temperatures to achieve consistent film thickness as the liquid essentially “self-flattens” onto the surface being coated, thus creating a smooth and uniform layer.

### DESCRIPTION OF THE EMBODIMENTS

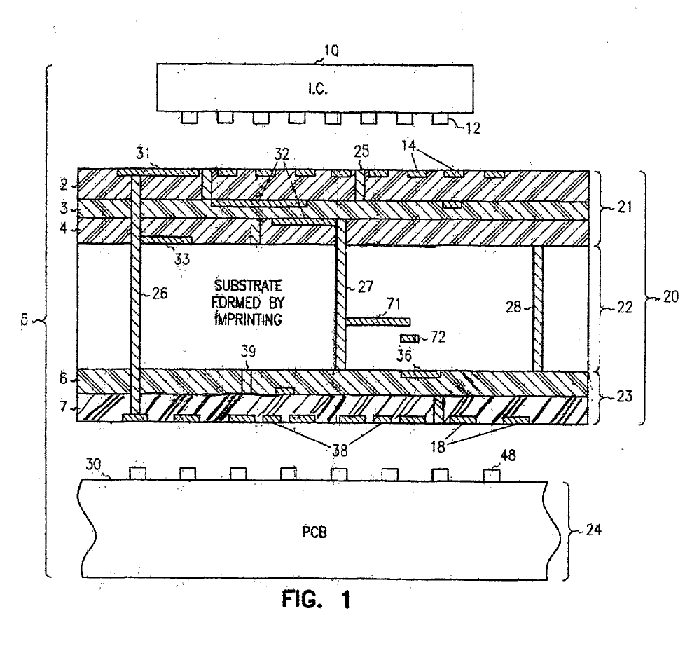

FIG. 1 illustrates a cross-sectional representation of an electronic assembly 5 incorporating a substrate 20 that is formed by an imprinting process that begins with application of an “A-stage” thermoset, in accordance with an embodiment of the invention.

The electronic assembly 5 shown in FIG. 1 includes at least one integrated circuit (IC) 10 or other type of active or passive electronic component having a plurality of conductive mounting pads 12. The electronic component may be in either packaged or unpackaged form, as appropriate to the type of substrate 20. The IC 10 (or other type of electronic component) may be of any type, including a microprocessor, a micro controller, a graphics processor, a digital signal processor (DSP), or any other type of processor or processing circuit. Other types of electronic components that may be included in electronic assembly 5 are a custom circuit, an application-specific integrated circuit (ASIC), or the like, such as, for example, one or more circuits (such as a communications circuit) for use in wireless devices such as cellular telephones, pagers, computers, two-way radios, and similar electronic systems. The electronic assembly 5 may form part of an electronic system as defined herein.

The IC 10 is physically and electrically coupled to the substrate 20. In an exemplary embodiment, the IC pads 12 are coupled to corresponding lands 14 on the upper surface of upper build-up section 21 through a suitable attachment mechanism such as solder balls or bumps (not shown).

The electronic assembly 5 may include an additional substrate, such as a printed circuit board (PCB) 24 (or interposer), below the substrate 20. The substrate 20 may be physically and electrically coupled to the PCB 24. In an exemplary embodiment, the substrate pads 18 are coupled to the corresponding lands 48 on the upper surface 40 of the PCB 24 through a suitable attachment mechanism such as solder (not shown). The PCB 24 can optionally have lands (not shown) on its lower surface for attachment to an additional substrate or other packaging structure in the packaging hierarchy.

In the example shown in FIG. 1, the substrate 20 comprises a core layer 22, an upper build-up section 21 of one or more layers, and a lower build-up section 23 of one or more layers. One of ordinary skill in the art will appreciate that many alternative embodiments are possible, including but not limited to a substrate comprising only a core layer; a substrate comprising a core with two or more upper and/or lower build-up layers; a substrate comprising a core with only upper build-up layer(s); a substrate comprising a core with only lower build-up layer(s); and so forth.

The various constituent layers of the substrate 20 can be formed of any suitable material or combination of materials as discussed herein. In general, the build-up layers 21 and 23 are thermoset resins that were applied as A-stage resins, allowed to cure sufficiently prior to imprinting, imprinted and then fully cured prior to the performance of subsequent steps known in the art and discussed herein.

The core layer 22, in the example shown in FIG. 1, comprises conductor features in the form of vias 26-28. The core layer 22 also comprises conductor features in the form of one or more internal trenches (e.g. traces 71 and 72). Some or all of the conductor features in the core layer 22 can be formed through an imprinting process and/or by conventional means, e.g., mechanical drilling.

The core layer 22 may be formed in various ways. For example, the core layer 22 may be formed as a single layer of material. Alternatively, the core layer 22 may comprise multiple layers of material. In the example shown in FIG. 1, the core layer 22 comprises multiple layers, and internal traces 71 and 72 are formed by conventional means in the vicinity of the boundaries between individual layers. The boundaries between the multiple layers making up the core layer 22 are not shown in FIG. 1. The internal traces 71 and 72 may be formed in any suitable manner, including a manner that is similar to or identical to that used to form trenches in the upper and lower build-up sections, 21 and 23, respectively.

In the example shown in FIG. 1, the upper build-up section 21 comprises three build-up layers 2-4. Any number of build-up layers can be used, depending on the particular application. The upper build-up section 21 further comprises conductor features in the form of one or more vias 25 and 26, one or more trenches (e.g. trace 31 and lands 14) in the upper surface of layer 2, and one or more trenches 33 in the lower surface of layer 4. The upper build-up section 21 may further comprise internal trenches 32, which may be formed in the internal upper and/or lower surfaces of layers 2-4, such as in the lower surface of layer 2, the upper or lower surfaces of layer 3, and/or in the upper surface of layer 4.

In the example shown in FIG. 1, the lower build-up section 23 comprises two build-up layers 6-7. Any number of build-up layers can be used, depending on the particular application. The lower build-up section 23 further comprises conductor features in the form of one or more vias 26 and 39, one or more trenches 36 in the upper surface of layer 6, and one or more trenches (e.g. traces 38 and pads 18) in the lower surface of layer 7.

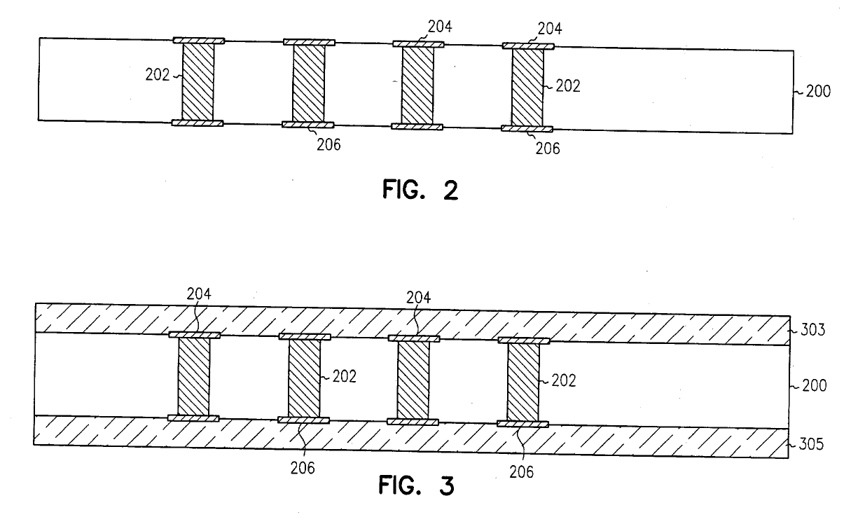

FIGS. 2-9 illustrate cross-sectional representations of the stages involved in imprinting a multi-layer substrate using a thermoset resin applied as an A-stage thermoset resin, i.e., varnish resin, (hereinafter “A-stage resin”) in embodiments of the invention. It is to be understood that each step described herein can optionally or necessarily comprise one or more substeps. Furthermore, not all steps described are depicted in FIGS. 2-9 and it is possible that additional steps not shown, such as adding additional upper and/or lower layers, can be performed at the appropriate points in the process.

FIG. 2 illustrates a cross-sectional representation of a first step in producing an imprinted substrate in which a core layer 200 having vias 202 has been provided, in accordance with an embodiment of the invention. The core layer 200 can be a conventional organic Fire Retardant Grade 4 (FR4) material as is known in the art and commonly used to manufacture printing wiring board or semiconductor packages. In another embodiment a low coefficient of thermal expansion (CTE) metal alloy such as Alloy 42 (typically containing approximately 42% nickel and 58% iron, as is known in the art) or Alloy 50 (typically containing approximately 50% nickel and 50% iron, as is known in the art), is used for the core layer 200. It should be noted that the core layer 202 may itself be comprised of multiple layers and can include internal traces positioned between such layers as discussed in FIG. 1. Such internal traces can be formed in any suitable manner as is known in the art.

The vias (or PTHs) 202 in the core layer 200 can be mechanically drilled as is known in the art. In this embodiment, the vias 202 are solid cylinders filled with a suitable polymer, such as a highly filled epoxy. (A highly filled epoxy resin is an epoxy resin mixed with more than 30% by volume of a suitable inert material, e.g., silicon dioxide, as filler, to decrease the amount of volume shrinkage normally experienced when a thermoset resin is fully cured). The walls of the vias 202 are plated with a suitable metallized component (represented by cross-hatching), such as copper, using conventional plating techniques known in the art. The vias 202 further each have an upper and lower metallized surface, 204 and 206, respectively, as shown in FIG. 2. Each surface 204 and 206 is formed through conventional plating techniques using any suit able material, such as copper.

FIG. 3 illustrates a cross-sectional representation of a subsequent step in which the upper and lower surfaces of the core layer 200 have been coated with a suitable thickness of an A-stage resin to produce upper and lower A-stage resin layers, 303 and 305, respectively, in accordance with an embodiment of the invention. In another embodiment, only one surface of the core layer 200 is coated with the A-stage resin. Although the vias 202 shown in FIG. 3 are not filled with the A-stage resin since they are solid, other exposed hollow vias as well as trenches (not shown) in the core layer 202 would necessarily become filled with the A-stage resin. The A-stage resin used to form the A-stage resin layers 303 and 305 can include, but is not limited to, epoxy resins (“epoxies”), polyimide resins (“polyimides”), bismaleimide resins (e.g., bismaleimide trizaine (BT)) and combinations thereof. In one embodiment, the thermoset resin contains particulates such as alumina or silicon dioxide. Such particulates are known to improve the CTE characteristics of the cured substrate.

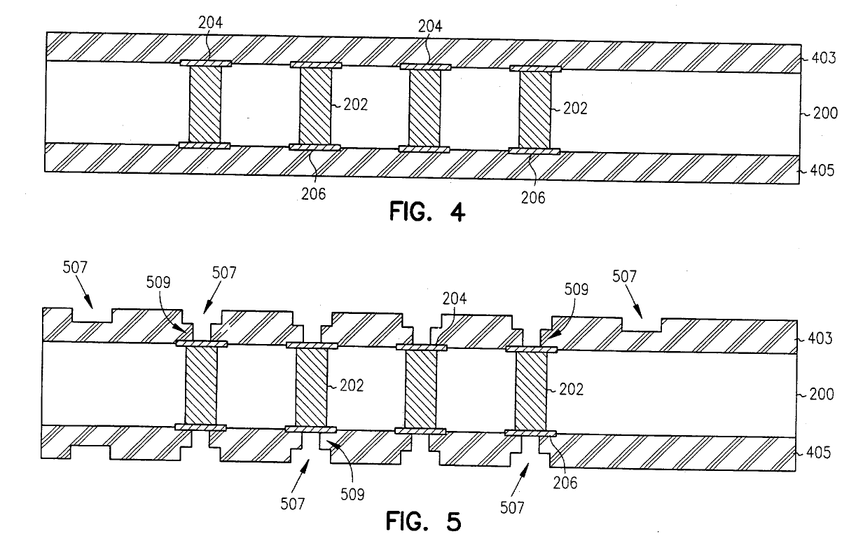

The A-stage resin is typically dissolved in a suitable solvent as noted above. Examples include, but are not limited to, 2-butanone, n,n-dimethylformamide, cyclohexanone, naptha, xylene, methoxypropynol and any combination thereof. The A-stage resin layers 303 and 305 can be any suitable thickness. In most embodiments, the A-stage resin layers 303 and 305 each have a thickness of between about 30 and 50 microns. The A-stage resin layers 303 and 305 are then partially cured in preparation for the imprinting process, as shown in FIG. 4.

FIG. 4 illustrates a cross-sectional representation of a subsequent step in which the upper and lower A-stage resin layers, 303 and 305, respectively, of FIG. 3, have been partially cured to produce upper and lower partially cured resin layers, 403 and 405, respectively, in accordance with an embodiment of the invention. The A-stage resin layers 303 and 305 should be allowed to cure well past the B-stage. In one embodiment, the partially cured resin layers 403 and 405 are 40 to 80% cured, as measured by DSC. At levels below a 40% cure, the imprint tool used to form imprints in the resin can permanently bond to the partially cured resin. At such levels, the imprinted feature can even disappear or melt away after the imprinting tool is removed. Additional curing up to between about 40 and 80% also ensures a well-defined imprint and prevents the imprinted features from losing definition during subsequent heating (to reach 100% cure). However, curing beyond 80% does not obtain any further benefits and can actually cause the imprinting to become more difficult, as the material becomes too hard for the imprinting tool to be pressed into the surface.

Typically, after the core 202 is coated with the A-stage resin to the desired thickness as described herein, any solvents present are removed by conventional methods known in the art, such as with radiant or convection heat. This can take anywhere from about one (1) to 20 minutes at temperatures of between about 100 to 200° C., depending on the particular solvent being used, the thickness of the coating from which the solvent is being removed, and so forth. After the solvent is removed, the resin in the A-stage resin layers (303 and 305) is advanced to at least a 40% but not more than 80% cure through any suitable heating process, such as baking in a properly designed convection oven. This can take anywhere from about 10 to 40 minutes at temperatures of between about 100 to 250° C., although the actual time and temperature is dependent on the specific material being used, degree of curing desired, and so forth. Therefore, to advance from an A-stage thermoset resin to the partially cured resin of layers 403 and 405, it typically takes a total of about 11 to 60 minutes at temperatures of between about 100 to 250° C., again, dependent on a number of conditions.

In one embodiment, the partially cured resin layers 403 and 405 are made from an epoxy resin, with each layer having been first “dried” removing the solvent, which takes about one (1) to 20 minutes at temperatures of about 50 to 150° C., again, with the specific conditions dependent on the specific solvent/solvent blend, coating thickness, etc. The epoxy resin is then cured to at least 40%, but not more than 80% for about 10 to 40 minutes at temperatures of about 100 to 150° C. In another embodiment, the partially cured resin layers 403 and 405 are made from a polyimide, with each layer having been first “dried” by first removing the solvent, which takes about one (1) to 20 minutes at temperatures of about 50 to 150° C., again, with the specific conditions dependent on a number of conditions, including the specific solvent/solvent blend, coating thickness, etc. The polyimide is then cured to at least 40%, but not more than 80% for about 10 to 40 minutes at a temperature of about 100 to 250° C.

It is important to note that the various layers do not necessarily need to be made from the same materials nor cured under the same conditions. It is also important to note that the curing of most thermoset resins is a linear relationship between temperature and time such that cure times are generally inversely proportional to cure temperatures. (For example, if it takes one hour at 200° C. for a material to fully cure, the same material will yield about a 50% cure after 30 minutes at the same temperature). Any suitable source of energy, such as thermal energy using convection (e.g., with heating coils, oven, etc.), infrared energy, and the like, can provide the heat necessary for the curing process.

FIG. 5 illustrates a cross-sectional representation of a subsequent step in which the core layer 200 having the upper and lower partially cured resin layers, 403 and 405, respectively, has been imprinted to form a plurality of trenches 507 and vias 509 as shown, in accordance with an embodiment of the invention. The imprinting can be performed with any suitable imprinting tool as is known in the art. In most embodiments, the imprinting of the layers 403 and 405 occurs substantially simultaneously with the imprinting apparatus properly aligned so that the resulting conducting features (trenches, vias, etc.) in the layers 403 and 405 are properly registered with the core layer 202, as is known in the art. Since the various trenches and vias are formed simultaneously on the opposite sides of the substrate surface, the need for via pads to assist in aligning or registering a particular via with a particular trench is eliminated. By eliminating the need for via pads, the core layer 202 can accommodate a higher density of conductor features, such as vias, traces, mounting terminals, and the like. In another embodiment, the conductor features are imprinted sequentially on one surface at a time. In yet another embodiment, only one surface is imprinted.

The imprinting tool or dies can optionally have different geometries to optionally produce conductor features having different geometries, i.e., different depths, widths, lengths, thicknesses, etc. The dies can also provide a combination of at least two different geometries, such as a wide region at its base (to form a trench) and a narrower region contiguous therewith (to form a via). Shorter dies may provide an imprint that does not extend beyond the top layer when the imprinting element is pressed against the top layer. Longer dies may provide an imprint that does extend through the top layer. Any number of combinations of conductor features can be produced. For example, vias may be formed outside of trenches or within trenches, as desired. The vias may be centered within a trench or be located along the side of a trench.

Excess resin can then be removed from the bottom of the imprinted vias 506 using conventional means such as plasma or permanganate chemistries as is known in the art.

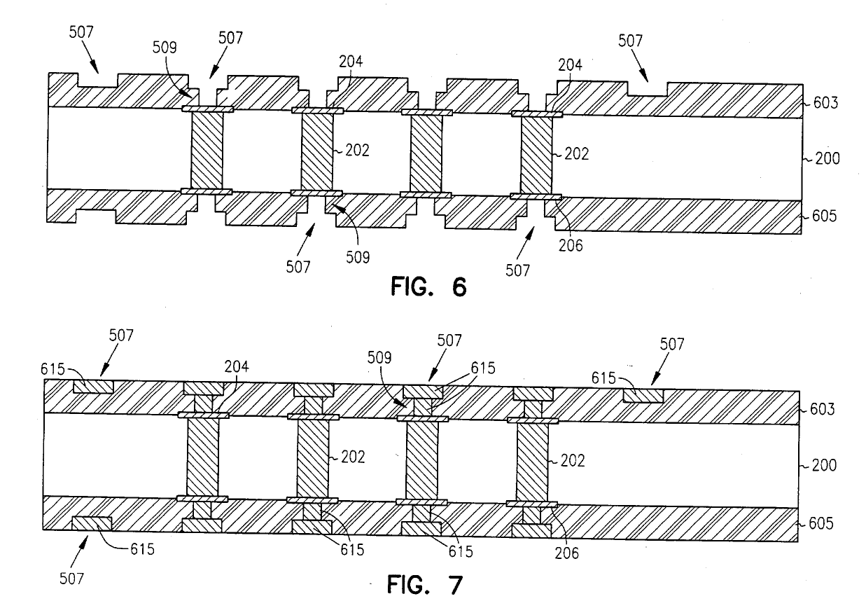

FIG. 6 illustrates a cross-sectional representation of a subsequent step in which the upper and lower partially cured resin layers, 403 and 405, respectively, of FIG. 5, have been fully cured to produce upper and lower fully cured resin layers, 603 and 605, respectively, in accordance with an embodiment of the invention. Typically, it takes about 30 to 60 minutes at temperatures of between about 150 to 250° C. for the partially cured resin layers (403 and 405) to fully cure (100%), although the actual time and temperature is dependent on the specific material being used, thickness of the layers, etc.

In one embodiment, the fully cured resin layers are C-stage resin layers 603 and 605 are made from an epoxy resin, with each layer having been cured at a temperature of about 150° C. for about 30 to 60 minutes. In another embodiment, the C-stage resin layers 603 and 605 are made from a polyimide, with each layer having been cured at a temperature of about 200 to 250° C. for about 30 to 60 minutes. Again, the actual times and temperatures can vary considerably depending on a number of conditions and the various layers do not necessarily need to be cured under the same conditions. However, it is important that the resin layers are fully cured prior to subsequent plating operations.

FIG. 7 illustrates a cross-sectional representation of a subsequent imprinting step in which conventional plating and planarizing processes have been performed on exposed surfaces of the C-stage layers 603 and 605, in accordance with an embodiment of the invention. Specifically, following the imprinting step of FIG. 6, the exposed surfaces are sensitized (i.e., a seed layer is applied) and copper-plated using conventional electroless copper plating processes. The surfaces, including the imprinted trenches 507 and vias 509 have also been panel plated to fill the imprinted features preferentially and the exposed surfaces secondarily. As FIG. 7 shows, the trenches 507 and vias 509 now contain conductive material 615, represented by the cross-hatching. Excess plating has been removed to reveal the copper plated, imprinted features shown in FIG. 7. Excess plating is typically removed through a grinding process as is known in the art. Essentially the excess or overplating material is ground down to the level of the exposed surfaces. In other embodiments, etching and/or chemical mechanical polishing (CMP) can be used to remove excess material. At this point, the exposed surfaces (now covered with plating material) are treated, such as with copper oxidizing chemistry, to promote adhesion of a subsequent polymer coating (not shown). Essentially, the treatment oxidizes the copper surface, causing it to become more porous and mechanically rough.

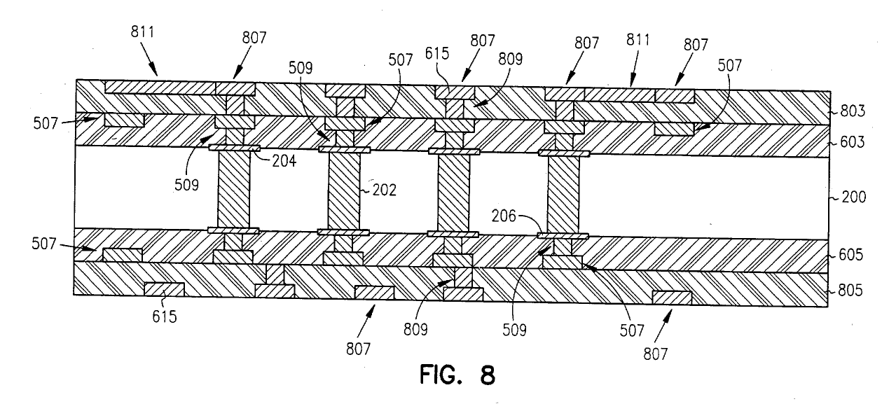

FIG. 8 illustrates a cross-sectional representation of a subsequent imprinting step in which additional upper and lower layers, 803 and 805, have been added to the core layer of FIG. 7 to produce a multilayer imprinted package, in accordance with an embodiment of the invention. The additional layers 803 and 805 have been formed by the processes as described above and shown in FIGS. 3-7. Each have a plurality of trenches 807 (lands) and 811 (traces) as well as vias 809 containing a conductive material 615, again represented by the cross-hatching. The longer trenches, i.e., traces 811 are, in some instances, contiguous with the smaller trenches 807 (lands).

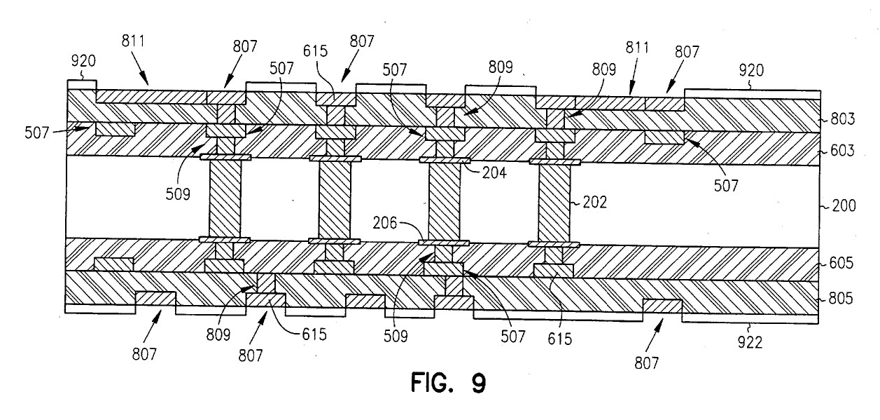

FIG. 9 illustrates a cross-sectional representation of a subsequent imprinting step in which an upper soldermask layer 920 and lower soldermask layer 922 together with final surface finishes (not shown) have been applied to the respective exposed surfaces of the additional upper and lower layers 803 and 805, in accordance with an embodiment of the invention. The soldermask layers 920 and 922 have been applied using techniques known in the art. The final finish on the exposed metal features has also been applied using conventional techniques. In one embodiment, the package is produced using electroless nickel, immersion gold plating or electrolytic nickel and gold or direct immersion gold.

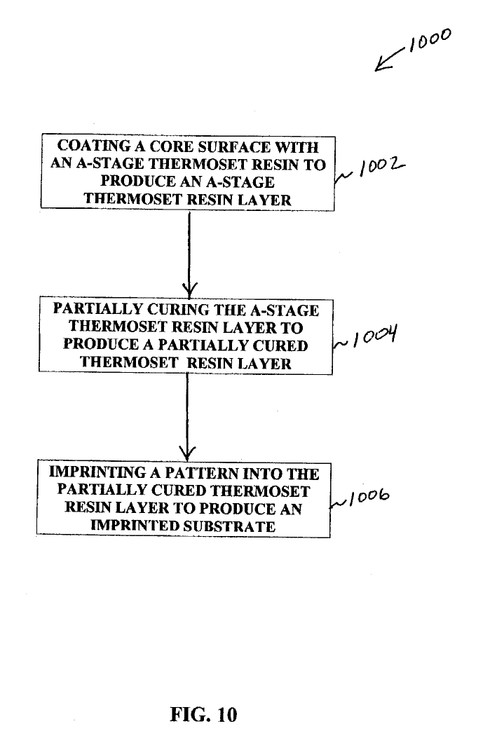

FIG. 10 is a block diagram illustrating a method of producing an imprinted substrate, in accordance with an embodiment of the invention. The process 1000 begins with coating 1002 a core surface with an A-stage thermoset resin to form an A-stage thermoset resin layer. The process continues with partially curing 1004 the A-stage thermoset resin layer to produce a partially cured resin layer and imprinting 1006 a pattern (i.e., a plurality of conductor features) into the partially cured thermoset resin layer to produce an imprinted substrate. In one embodiment, the thermoset resin layer is about 40 to 80% cured prior to the imprinting step. The partially cured thermoset resin layer is fully cured prior to additional processing steps. In one embodiment, both surfaces of the core layer are imprinted simultaneously. In another embodiment, the entire process is repeated with additional layers on top of the one or more original imprinted substrate layers.

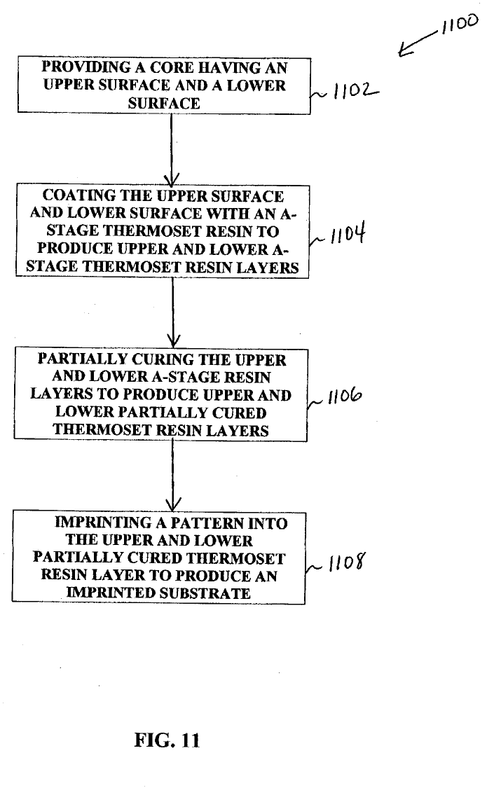

FIG. 11 is a block diagram illustrating a method of producing an imprinted substrate, in accordance with an embodiment of the invention. The process 1100 begins with providing 1102 a core having an upper surface and a lower surface; coating 1104 the upper surface and lower surface with an A-stage thermoset resin to produce upper and lower A-stage thermoset resin layers; partially curing 1106 the upper and lower A-stage resin layers to produce upper and lower partially cured thermoset resin layers; and imprinting 1108 a pattern into the upper and lower partially cured thermoset resin layer to produce an imprinted substrate.

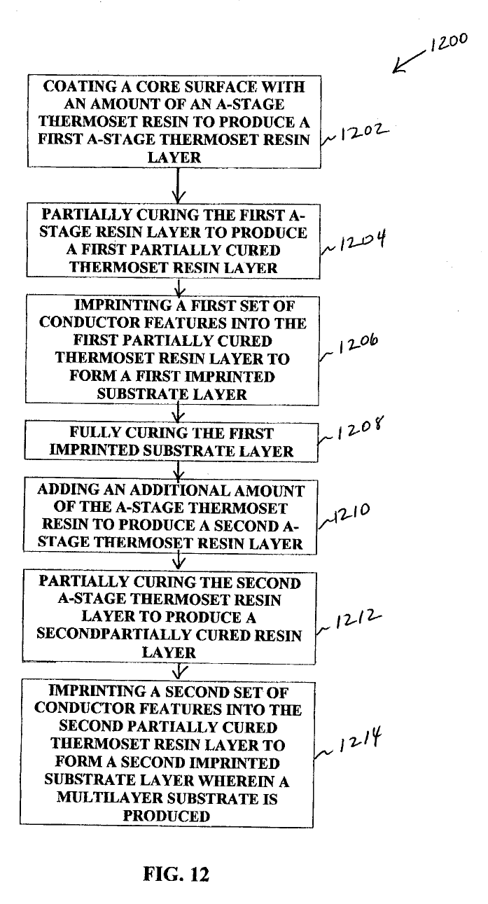

FIG. 12 is a block diagram illustrating a method of producing a multilayer imprinted substrate, in accordance with an embodiment of the invention. The process 1200 begins with coating 1202 a core surface with an amount of an A-stage thermoset resin to produce a first A-stage thermoset resin layer; partially curing 1204 the first A-stage resin layer to produce a first partially cured thermoset resin layer; imprinting 1206 a first set of conductor features into the first partially cured thermoset resin layer to form a first imprinted substrate layer; fully curing 1208 the first imprinted substrate layer; adding 1210 an additional amount of the A-stage thermoset resin to produce a second A-stage thermoset resin layer; partially curing 1212 the second A-stage thermoset resin layer to produce a second partially cured resin layer; and imprinting 1214 a second set of conductor features into the second partially cured thermoset resin layer to form a second imprinted substrate layer.

### CONCLUSION

Embodiments of the present invention provide for electronic substrates that can be fabricated with relatively less complexity, time, and cost, and with relatively greater density compared with known electronic substrates. The application of a thermoset resin in the A-stage, according to embodiments of the invention, provides a novel approach to producing substrates, including multi layer substrates, in a cost efficient and simple manner, with all the advantages noted herein.

An electronic system that incorporates one or more electronic assemblies that utilize the present subject matter can be produced in configurations having reduced cost and enhanced reliability relative to known structures and fabrication methods, and such systems are therefore more commercially attractive.

As shown herein, the present subject matter can be implemented in a number of different embodiments, including an electronic package substrate, an electronic package, and various methods of fabricating a substrate. Other embodiments will be readily apparent to those of ordinary skill in the art. The elements, materials, geometries, dimensions, and sequence of operations can all be varied to suit particular packaging requirements.

FIGS. 1 through 9 are merely representational and are not drawn to scale. Certain proportions thereof may be exaggerated, while others may be minimized. FIGS. 1-9 are intended to illustrate various implementations of the subject matter that can be understood and appropriately carried out by those of ordinary skill in the art.

Although specific embodiments have been illustrated and described herein, it will be appreciated by those of ordinary skill in the art that any arrangement that is calculated to achieve the same purpose may be substituted for the specific embodiment shown. This application is intended to cover any adaptations or variations of the present subject matter. Therefore, it is manifestly intended that embodiments of this invention be limited only by the claims and the equivalents thereof.

What is claimed is:

1. A method comprising:
coating a core surface with an A-stage thermoset resin to produce an A-stage thermoset resin layer;
partially curing the A-stage resin layer to produce a partially cured thermoset resin layer; and
imprinting a plurality of conductor features into the partially cured thermoset resin layer to produce an imprinted substrate.

2. The method of claim 1 wherein, in partially curing, the A-stage thermoset resin is partially cured to between 40 and 80%.

3. The method of claim 2 wherein, in partially curing, the A-stage thermoset resin is heated to about 100 to 250° C. for about 11 to 60 minutes.

4. The method of claim 1 wherein the A-stage thermoset resin is a material combined with a solvent, the material selected from the group consisting of epoxy resins, polyimide epoxies, bismaleimide epoxies and combinations thereof.

5. The method of claim 4 wherein the bismaleimide epoxy is bismaleimide trizaine.

6. The method of claim 4 wherein the solvent is selected from the group consisting of 2-butanone, n,n-dimethylformamide, cyclohexanone, naptha, xylene, methoxypropynol and any combination thereof.

7. The method of claim 1 wherein the plurality of conductor features comprises a plurality of trenches and vias.

8. The method of claim 7 further comprising removing excess resin from the plurality of trenches and vias.

9. The method of claim 2 further comprising:
completely curing the imprinted substrate to produce a fully cured resin layer having an exposed surface;
applying a seed layer to the exposed surface; and
plating the exposed surface to produce a plated surface.

10. The method of claim 9 wherein the seed layer is applied using an adsorption solution.

11. The method of claim 9 wherein, in completely curing, the partially cured resin layer is heated to about 100 to 250° C. for about 30 to 90 minutes.

12. The method of claim 9 further comprising applying a soldermask to the plated surface.

13. The method of claim 9 further comprising:
treating the plated surface with an oxidizer;
coating the plated surface with an A-stage thermoset resin to produce an additional A-stage thermoset resin layer;
partially curing the additional A-stage resin layer to produce an additional partially cured thermoset resin layer; and
imprinting a pattern into the additional partially cured thermoset resin layer to produce a multilayer imprinted substrate.

14. The method of claim 2 wherein the core layer has a top surface and a bottom surface, further wherein the top surface is coated with the A-stage thermoset resin to form an upper A-stage thermoset resin layer and the bottom surface is coated with the A-stage thermoset resin to form a lower A-stage thermoset resin layer.

15. The method of claim 14 wherein the upper and lower A-stage thermoset resin layers are partially cured to form upper and lower partially cured thermoset resin layers, further wherein the upper and lower partially cured thermoset resin layers are imprinted simultaneously.

16. A method comprising:
providing a core having an upper surface and a lower surface;
coating the upper surface and lower surface with an A-stage thermoset resin to produce upper and lower A-stage thermoset resin layers;
partially curing the upper and lower A-stage resin layers to produce upper and lower partially cured thermoset resin layers; and
imprinting a pattern into the upper and lower partially cured thermoset resin layer to produce an imprinted substrate.

17. The method of claim 16, wherein imprinting a pattern comprises imprinting simultaneously a plurality of vias and trenches.

18. The method of claim 16, wherein the A-stage thermoset resin is an epoxy resin.

19. A method comprising:
coating a core surface with an amount of an A-stage thermoset resin to produce a first A-stage thermoset resin layer;
partially curing the first A-stage resin layer to produce a first partially cured thermoset resin layer;
imprinting a first set of conductor features into the first partially cured thermoset resin layer to form a first imprinted substrate layer;
fully curing the first imprinted substrate layer;
adding an additional amount of the A-stage thermoset resin to produce a second A-stage thermoset resin layer;
partially curing the second A-stage thermoset resin layer to produce a second partially cured resin layer; and
imprinting a second set of conductor features into the second partially cured thermoset resin layer to form a second imprinted substrate layer.

20. The method of claim 19 wherein the first imprinted substrate layer is metallized with conventional plating techniques prior to adding the additional amount of the A-stage thermoset resin.

21. The method of claim 19 further comprising simultaneously imprinting conductor features into an opposing substrate layer, the opposing substrate layer located on an opposite core surface, the opposing substrate layer formed from an A-stage resin layer that has partially cured.

22. The method of claim 21 wherein pressure is not applied to either the first imprinted substrate layer ot the second A-stage thermoset resin layer.

23. An electronic package substrate comprising:
a layer to mount an electronic component; and
a plurality of conductor features in the layer, wherein the plurality of conductor features are formed by imprinting with a thermoset resin, the thermoset resin applied as an A-stage resin and partially cured prior to imprinting.

24. The electronic package substrate of claim 23, wherein the varnish resin is selected from the group consisting of epoxy resins, polyimide epoxies, bismaleimide epoxies and combinations thereof.

25. The electronic package substrate of claim 23 wherein the partially cured resin is cured at least 40% but not more than 80%.

26. The electronic package substrate of claim 23 wherein the layer is metallized, further wherein the partially cured resin is fully cured prior to being metallized.

27. The electronic package substrate of claim 23 further comprising a second layer to mount an electronic component, the second layer located on top of the first layer.

28. An electronic package comprising:
a substrate having a plurality of conductor features formed by imprinting, the substrate formed from an A-stage resin that is partially cured prior to imprinting; and
an electronic component coupled to the substrate.

29. The electronic package recited in claim 26, wherein the electronic component comprises an unpackaged integrated circuit.

30. The electronic package recited in claim 26, wherein the electronic component comprises a packaged integrated circuit.
